(19) United States
(12) Patent Application Publication
(10) Pub. No.: US 2014/0218772 A1
(43) Pub. Date: Aug. 7, 2014

(54) DOCUMENT READING APPARATUS

(71) Applicant: CANON KABUSHIKI KAISHA, Tokyo (JP)

(72) Inventor: Takahisa Koshimizu, Toride-shi (JP)

(73) Assignee: CANON KABUSHIKI KAISHA, Tokyo (JP)

(21) Appl. No.: 14/168,150

(22) Filed: Jan. 30, 2014

(30) Foreign Application Priority Data
Feb. 5, 2013 (JP) 2013-020757

(51) Int. Cl. H04N 1/053; H04N 1/407

(52) U.S. Cl. CPC H04N 1/053; H04N 1/4076
USPC 358/461; 358/488

(57) ABSTRACT

An image reading apparatus corrects a deviation of a reading position of a document to accurately correct a luminance intensity distribution variation. Light is radiated to a shading plate (102) provided at a portion different from a reading position (luminance-intensity-distribution-variation correction reading line 103b) for a document (P) while displacing an illumination unit (101), and shading correction is carried out based on a luminance value of reflection of the light. Light is radiated to the reading position before the document (P) is transported thereto while displacing the illumination unit (101) in the same direction as a displacement direction of the illumination unit (101) at a time of performing shading correction. The luminance value of the reflected light at this time is compared with the luminance value after the shading correction to generate luminance-value reference data before the reading of the document.

### BACKGROUND OF THE INVENTION

1. Field of the Invention

The present invention relates to correction of an image reading position of an image reading apparatus that is used in a copying machine, a fax machine, and the like.

2. Description of the Related Art

Known image reading apparatus such as a copying machine and a document scanner include a type that performs what is called “document flow reading” of, while transporting documents, continuously reading images of the documents at a fixed position on a document glass table onto which the documents are fed one by one by an automatic document feeder.

In performing document flow reading of continuously reading documents, a shading correction value is acquired before the first document is read, and the same shading correction value is used for documents to be continuously read. In document flow reading, an illumination unit for irradiating a portion of a document to be read with light, such as a light source including a rare-gas fluorescent lamp typified by a white xenon lamp and a light emitting diode (LED) array, is lit continuously. This causes a variation in the quantity of light (variation in luminance value), such as a reduction in the quantity of light from the light source as a whole due to an increase in temperature of the light emitting part of the illumination unit, or a local reduction in the quantity of light in the main scanning direction due to a difference in the internal heat distribution. This variation in the quantity of light changes the light intensity distribution in the main scanning direction, which causes a problem of degrading the quality of the read image.

As a solution to such a problem, an image reading apparatus disclosed in U.S. Pat. No. 7,327,497 is configured to include a first density reference member and a second density reference member and to read the second density reference member before reading a document and after reading at least one document. Based on those reading results, a change in luminance is detected to compute a correction value, based on which what is called distribution-variation correction is carried out.

At the time of document flow reading, however, heat generated from a motor for transporting documents, the light source, and the like raises the internal temperature. The increased internal temperature may change the inclination angle of the mirror that guides reflected light from the front surface of a document to a light condensing unit. In this case, the change in inclination angle displaces the position at which reading of a document starts (leading edge position of the document) in a sub scanning direction. That is, the reading position deviates. This deviation changes the angle formed by the light source and the reference member for detecting a luminance intensity distribution variation, with the result that the reflection components from the reference member increase. Apparently, there still remains a problem in that the correction value for the luminance intensity distribution variation is computed to be larger than the actual correction value.

### SUMMARY OF THE INVENTION

According to one embodiment of the present invention, it is an object to provide an image reading apparatus capable of correcting a deviation of a reading position to accurately correct a luminance intensity distribution variation.

An image reading apparatus according to one embodiment of the present invention includes a light source, a motor for displacing the light source, document transporting means for transporting a document to a predetermined reading position, luminance value acquisition means for acquiring a luminance value of reflected light emitted from the light source, a shading plate of a reference color provided at a portion different from the reading position, a shading correction circuit for performing shading correction based on the luminance value of the reflected light when light is radiated onto the shading plate while displacing the light source, luminance-value reference data acquisition means for generating luminance-value reference data before reading of the document by comparing the luminance value of the reflected light when light is radiated onto the reading position before the document is transported while displacing the light source in the same direction as a displacement direction of the light source at a time of performing the shading correction with the luminance value of the reflected light after the shading correction, detection means for detecting whether there is a variation in a quantity of light by comparing the luminance-value reference data with a luminance value of the reflected light when light is radiated again onto the reading position without the document present thereat while displacing the light source in the same direction as the displacement direction of the light source at the time of performing the shading correction after the document is read at the reading position, and control means for controlling the motor or the document transporting means to displace the reading position relatively when a variation of a predetermined light quantity or more occurs.

The image reading apparatus according to one embodiment of the present invention detects light radiated onto and reflected from the surface of a reading position at a predetermined timing to be able to calculate a variation in the quantity of light (variation in luminance) of the specular reflected light component in the main scanning direction. The amount of displacement of the reading position is calculated from the variation in luminance, and the reading position is displaced relatively to cancel the amount of displacement. This makes it possible to correct a deviation occurring at the document reading position without employing a complicated configuration. Further, the image reading apparatus can accurately correct luminance intensity distribution variation, thus ensuring accurate image reading.

Further features of the present invention will become apparent from the following description of exemplary embodiments (with reference to the attached drawings).

### BRIEF DESCRIPTION OF THE DRAWINGS

FIG. 1 is a schematic longitudinal cross-sectional view of an image reading apparatus according to a first embodiment of the present invention.

FIG. 2 is a block diagram illustrating an example of a control circuit of the image reading apparatus.

FIG. 3 is a diagram illustrating an example of the configuration of an illumination unit.

FIG. 4 is a schematic configuration diagram of an LED array light source mounted in the illumination unit.

FIG. 5 is a diagram illustrating a document reading position and a luminance-intensity-distribution-variation correction reading line on a document flow reading guide.

FIG. 6 is a diagram illustrating “deviation” occurring on the luminance-intensity-distribution-variation correction reading line on the document flow reading guide.

FIG. 7 is a diagram illustrating a phenomenon that “deviation” occurs on the luminance-intensity-distribution-variation correction reading line.

FIG. 8 is a schematic diagram illustrating a luminance distribution on the luminance-intensity-distribution-variation correction reading line when the inclination angle of a mirror changes.

FIG. 9 is a graph showing the luminance distribution on the luminance-intensity-distribution-variation correction reading line before document flow reading starts.

FIG. 10 is a graph showing the luminance distribution on the luminance-intensity-distribution-variation correction reading line when “deviation” occurs on the luminance-intensity-distribution-variation correction reading line.

FIG. 11 is a graph showing the relation between a luminance variation and “deviation” of the luminance-intensity-distribution-variation correction reading line.

FIG. 12 is a flowchart illustrating procedures of a control process of the image reading apparatus.

FIG. 13 is a flowchart illustrating procedures of calculating a reading variation.

FIG. 14 is a diagram illustrating how to correct “deviation” occurring at a reading position by moving the illumination unit.

FIG. 15 is a schematic diagram illustrating the relation between a time at which reading of a document starts and the amount of deviation of the reading position.

FIG. 16 is a timing chart for reading when “deviation” does not occur at the reading position.

FIG. 17 is a timing chart for reading when “deviation” occurs at the reading position.

### DESCRIPTION OF THE EMBODIMENTS

Embodiments are now described referring to the accompanying drawings. The description is given of a case where light is radiated onto a reading position from a plurality of directions at the time of reading a document.

### First Embodiment

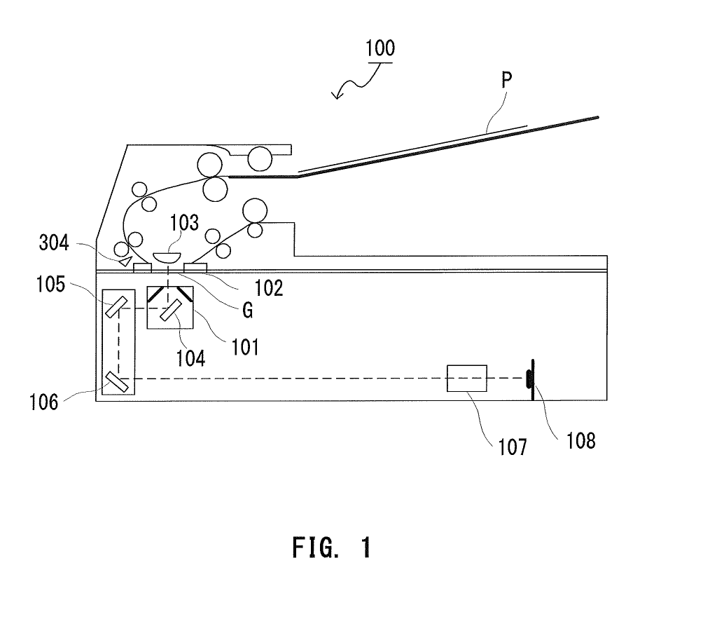

FIG. 1 is a schematic longitudinal cross-sectional view of an image reading apparatus according to a first embodiment of the present invention.

The image reading apparatus 100 is configured to include an illumination unit 101, a shading plate 102, a document flow reading guide 103, a mirror 104 provided in the illumination unit 101, mirrors 105 and 106, a condensing unit 107, and a light receiving sensor 108. The image reading apparatus 100 further includes a document detecting sensor 304 at a predetermined location of a transporting path for a document P so as to detect arrival and passage of the document P. The document P is transported to a reading position by individual transporting rollers provided in the image reading apparatus 100. The illumination unit 101 radiates light onto the document P passing on a document flow reading glass G located at the reading position. The shading plate 102 is a density reference member for shading correction, and has a reference color of white for correcting an influence on an image quality originating from an optical factor.

The shading plate 102 is disposed at a position different from the reading position. The document flow reading guide 103 has a cylindrical portion having an arcuate cross section with a predetermined radius of curvature. The document flow reading guide 103 guides the back of the transported document P with the curved surface of the cylindrical portion to suppress “lifting of a document.” The mirror 104 provided in the illumination unit 101 and the mirrors 105 and 106 are disposed to reflect light radiated onto and reflected from the document P and guide the reflected light to the condensing unit 107. The reflected light guided to the condensing unit 107 is condensed at the condensing unit 107, and is then converted (photoelectrically converted) into an electric signal by the light receiving sensor 108. The image of the document P is read in this manner.

The illumination unit 101 moves directly under the shading plate 102 before reading of the document P starts. The light receiving sensor 108 reads the surface of the shading plate 102 to acquire reference data for correcting a pixel-by-pixel variation in luminance value in the main scanning direction, such as ununiformity of the amount of illumination light or a variation in sensitivity of the light receiving sensor 108.

The reference data acquired when the light source of the illumination unit 101 is turned off is a black reference level A. The reference data acquired when the light source of the illumination unit 101 is turned on is a white reference level B.

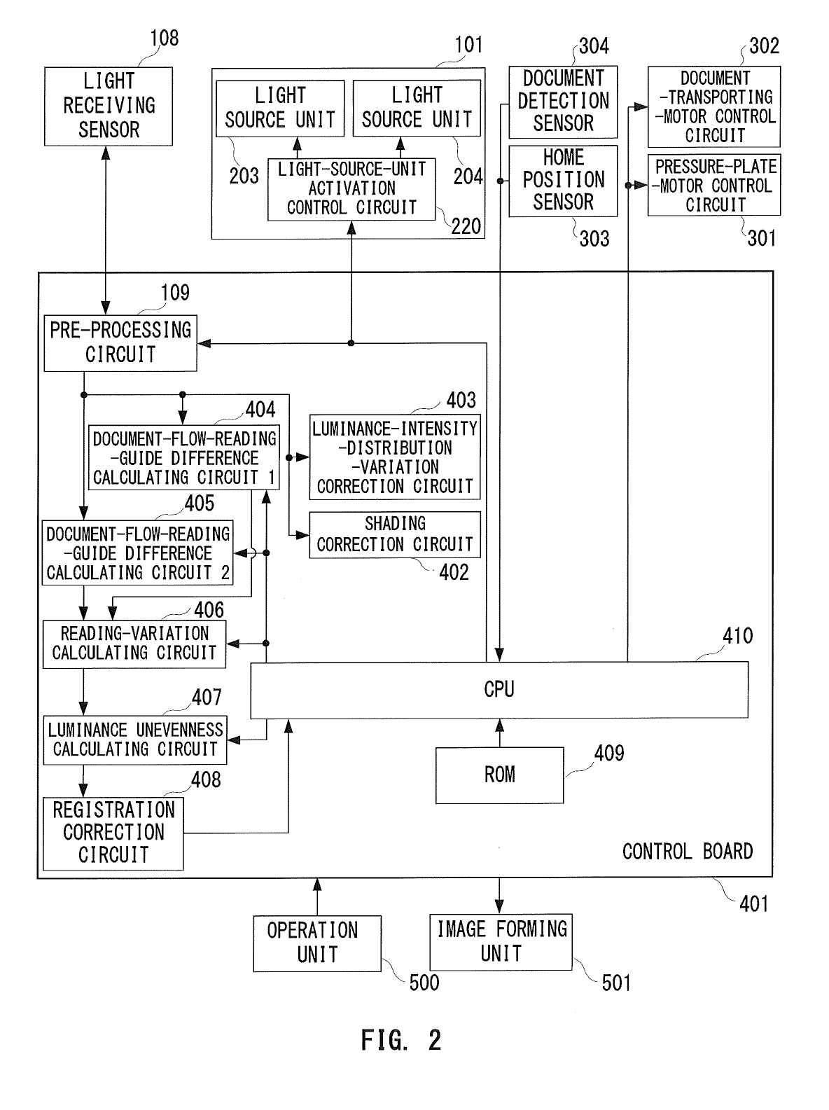

The image reading apparatus 100 includes a control circuit. FIG. 2 is a block diagram illustrating an example of the control circuit of the image reading apparatus 100. Same reference numerals are given to the components already illustrated in FIG. 1. A control board 401 has various circuits besides a ROM 409 and a CPU 410 mounted thereon. The CPU 410 controls the individual circuits in accordance with input information, such as setting of a reading mode and an instruction to start reading, input by a user via an operation unit 500. Various computer programs that are executed by the CPU 410 are stored in the ROM 409.

A pre-processing circuit 109 mounted on the control board 401 outputs a sampling pulse for image reading to the light receiving sensor 108 in response to the document reading start signal from the CPU 410. The light receiving sensor 108 receives light, and outputs an analog electric signal. The analog electric signal is then converted into digital data in the pre-processing circuit 109, and is transferred to the control board 401.

A shading correction circuit 402 mounted on the control board 401 performs shading correction based on the signal that is output by the light receiving sensor 108 after reading the shading plate 102. Specifically, before reading a first document P, the shading correction circuit 402 detects a pixel-by-pixel variation in luminance value of the light receiving sensor 108 based on data obtained by reading the shading plate 102, and adjusts the gain pixel by pixel in accordance with the result of the detection.

A luminance-intensity-distribution-variation correction circuit 403 mounted on the control board 401 calculates a correction value for correcting the luminance intensity distribution variation based on the signal that is output by the light receiving sensor 108 after reading the surface of the document flow reading guide 103. For example, the luminance-intensity-distribution-variation correction circuit 403 performs luminance-intensity-distribution-variation correction with the correction value calculated for a variation in luminance value originating from a change in the quantity of illumination due to a temperature rise, or a reduction in sensitivity of the light receiving elements, which occurs after shading correction.

Next, correction of a luminance intensity distribution variation is described specifically. After the light receiving sensor 108 reads the shading plate 102, the illumination unit 101 is moved directly under the document flow reading guide 103 to read the surface of the document flow reading guide 103 before a first document P is read. Next, the difference between the luminance value detected by reading the shading plate 102 and the luminance value detected by reading the document flow reading guide 103 is calculated. The result of the calculation is stored in a storage unit (not shown). Even after reading of the document P starts, the surface of the document flow reading guide 103 is read as needed, and the difference between the luminance value detected by reading the shading plate 102 and the luminance value detected by the current reading of the document flow reading guide 103 is calculated. Based on those differences, a variation in luminance value is calculated, and the gain is corrected to cancel the variation.

The illumination unit 101 has light source units 203 and 204, and a light-source-unit activation control circuit 220 mounted therein. Each of the light source units 203 and 204 is the light source of the illumination unit 101. The light-source-unit activation control circuit 220 turns the light source units 203 and 204 on or off, and adjusts the quantity of light therefrom under control of the CPU 410.

A pressure-plate-motor control circuit 301 drives a pressure plate motor (not shown) that drives the illumination unit 101. The pressure-plate-motor control circuit 301 corrects the reading position for reading the document P in cooperation with a registration correction circuit 408 mounted on the control board 401. The registration correction circuit 408 corrects registration (color deviation). The details of the registration correction circuit 408 are given later.

A document-transporting-motor control circuit 302 drives a document transporting motor (not shown) that drives the transporting rollers for transporting the document P. A home-position sensor 303 detects that the illumination unit 101 has reached a “home position,” namely, directly under the shading plate 102 and directly under the document flow reading guide 103. A document detection sensor 304 detects that the document P has reached a predetermined position, and outputs a signal to the CPU 410.

Based on the result of the detection of the document detection sensor 304, the CPU 410 controls the document-transporting-motor control circuit 302 so that the surface of the document flow reading guide 103 can be read between documents. Image data of the read document P is output to an image forming unit 501. As a result, an image is formed.

The details of a document-flow-reading-guide difference calculating circuit 1 (404), a document-flow-reading-guide difference calculating circuit 2 (405), a reading-variation calculating circuit 406, and a luminance unevenness calculating circuit 407 will be given later.

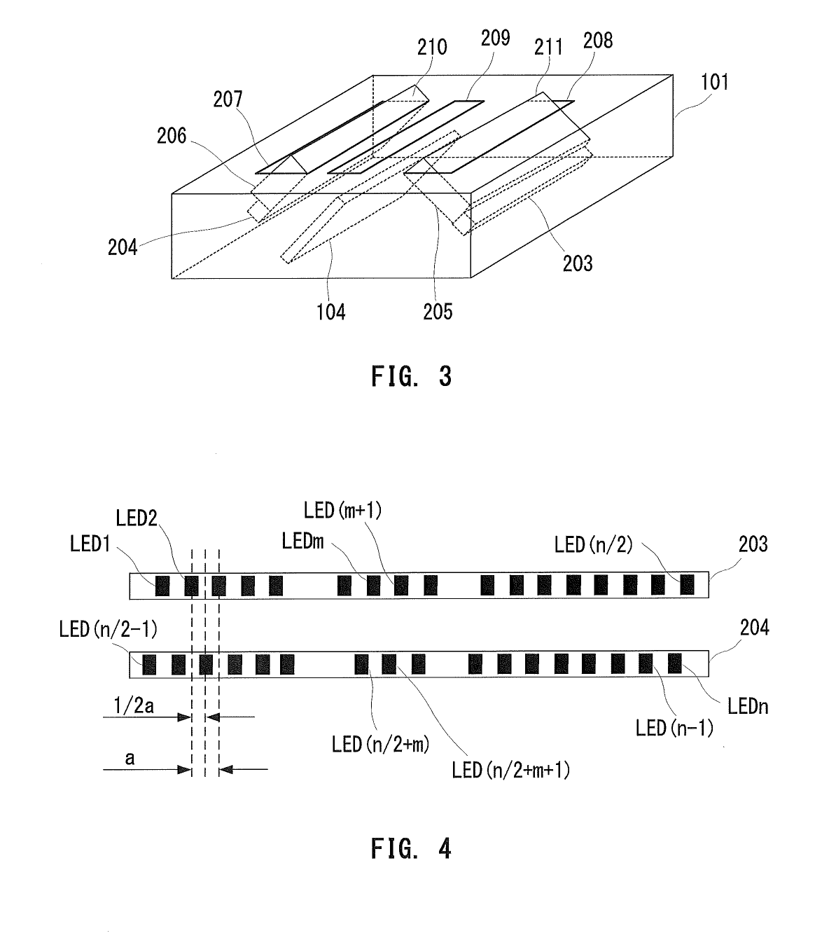

FIG. 3 is a diagram illustrating an example of the configuration of the illumination unit 101. FIG. 4 is a schematic configuration diagram of the light source units 203 and 204 mounted in the illumination unit 101. The general configuration of the illumination unit 101 is described referring to FIGS. 3 and 4.

The illumination unit 101 is configured to include the arrayed (LED array) light source units 203 and 204 having LEDs disposed in the main scanning direction in addition to the mirror 104. The main scanning direction refers to a direction that crosses the document transporting direction (sub scanning direction) at the reading position. The light source unit 203 is connected to a light guide member 205, and the light source unit 204 is connected to a light guide member 206. The light guide member 205 diffuses and reflects light received from the light source unit 203, and radiates the reflected light toward the document P from an irradiation surface 211. The light guide member 206 diffuses and reflects light received from the light source unit 204, and radiates the reflected light toward the document P from an irradiation surface 210. The light guide members 205 and 206 are disposed so as to radiate light toward the document P from left and right directions facing each other with the reading position at the center. That is, the light output from the light guide member 206 irradiates the reading position from the upstream side of the document transporting direction, and the light output from the light guide member 205 irradiates the reading position from the downstream side of the document transporting direction.

The irradiation surface 210 is disposed to protrude from a light-emitting slit part 207 of the illumination unit 101, and the irradiation surface 211 is disposed to protrude from a light-emitting slit part 208 of the illumination unit 101. The light-receiving slit parts 207 and 208, and a light-receiving slit part 209 that guides reflected light from the document P to the mirror 104 suppress occurrence of flare caused by ambient light.

The light source units 203 and 204 have n (n being a natural number of 2 or more) LEDs, LED1 to LEDn, in total disposed therein. As illustrated in FIG. 4, the light source unit 203 has n/2 LEDs arranged in the order of LED1, LED2, . . . , LEDm, LED(m+1), . . . , LED(n/2) from the left side as seen from the front of the figure. The light source unit 204 has the remaining LEDs arranged in the order of LED(n/2+1), . . . , LED(n/2+m), LED(n/2+m+1), . . . , LED(n−1), LEDn.

In each of the light source units 203 and 204, adjacent LEDs are arranged at a distance of a. As illustrated in FIG. 4, with the light source units 203 and 204 set to face each other, the LEDs of one of the light source units are located at positions shifted from the positions of the corresponding LEDs in the other light source unit by a distance of a/2. This arrangement of the LEDs ensures uniform illuminance of the reading position. That is, the positions of the LEDs disposed in the light source unit 203 in the main scanning direction differ from the positions of the LEDs disposed in the light source unit 204 in the main scanning direction.

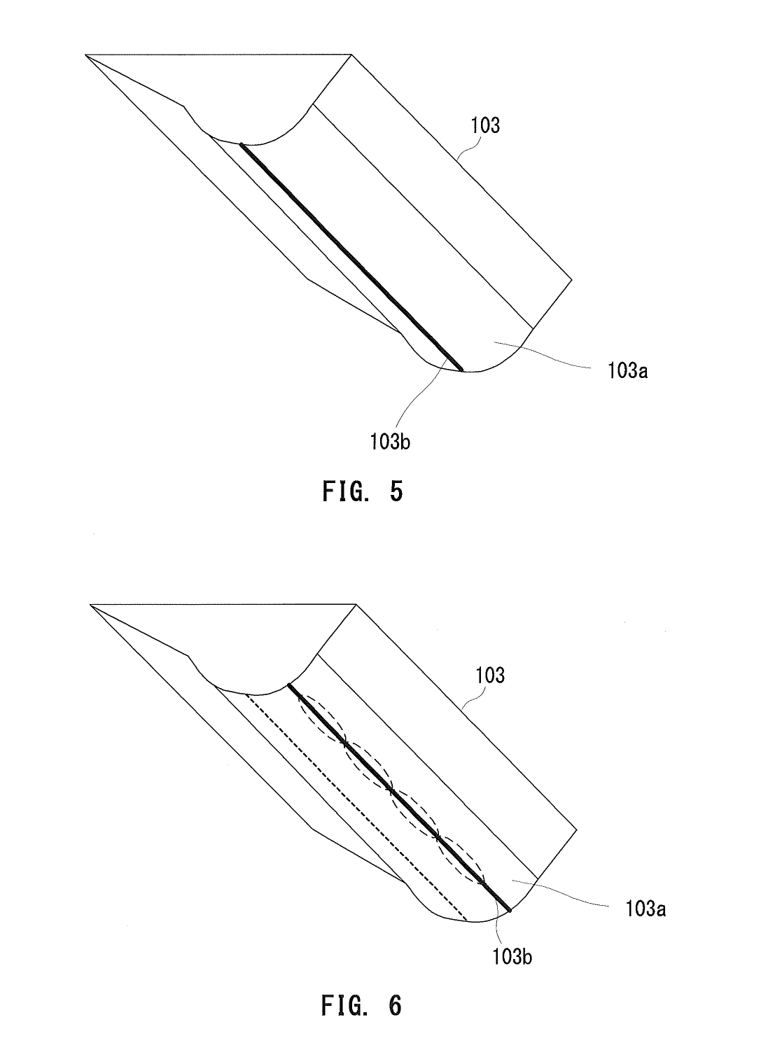

FIG. 5 is a schematic diagram illustrating the document flow reading guide 103 and a luminance-intensity-distribution-variation correction reading line on the document flow reading guide 103.

An axial line (straight portion) on a cylindrical surface formed by a cylindrical portion 103a with an arcuate cross section of the document flow reading guide 103 is located at the reading position where the document P is read. This line is also a luminance-intensity-distribution-variation correction reading line 103b for detecting a luminance value for correction of a luminance intensity distribution variation. The document P transported onto the document flow reading guide 103 is restricted so that the movement of the document P draws a gentle curve by the curved surface of the document flow reading guide 103 regardless of the entrance angle of the document P. When reading of the document P is carried out near the top of the cylindrical portion 103a, a good-quality image is obtained stably. The irradiation angle of light to be radiated toward the document P is adjusted so that the luminance becomes substantially uniform at the reading position, i.e., on the luminance-intensity-distribution-variation correction reading line 103b.

FIG. 6 is a diagram schematically illustrating “deviation” occurring on the luminance-intensity-distribution-variation correction reading line 103b on the document flow reading guide 103 when a given period of time passes after starting document flow reading. As described above, because the LEDs are continuously lit at the time of document flow reading, the temperature of the light source units 203 and 204 rises, and the inclination angle of the mirror 104 is displaced by the temperature rise. The displacement of the inclination angle of the mirror 104 causes “deviation” on the luminance-intensity-distribution-variation correction reading line 103b. In this case, the luminance value on the luminance-intensity-distribution-variation correction reading line 103b is detected such that irradiation from a bright point (LED) of one of the light source units 203 and 204 is intense while irradiation from a bright point (LED) of the other of the light source units 203 and 204 is weak. The luminance appears as light-source originated “waviness” in the main scanning direction on the surface of the document flow reading guide 103, as illustrated in FIG. 6.

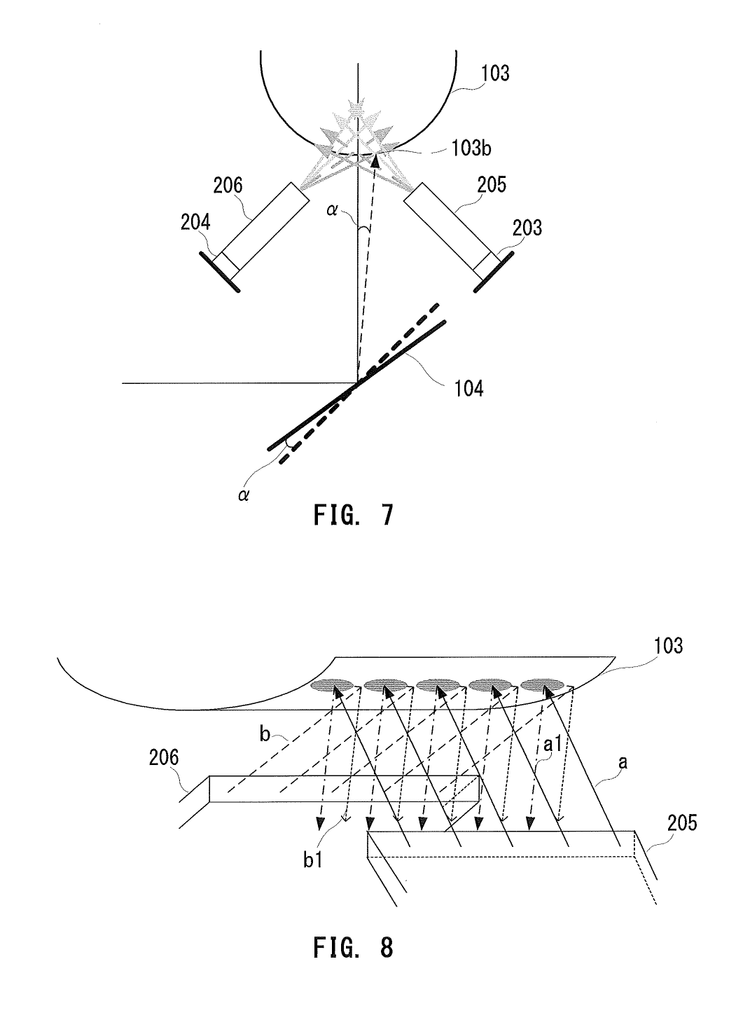

FIG. 7 is a diagram illustrating a phenomenon that “deviation” occurs on the luminance-intensity-distribution-variation correction reading line 103b. FIG. 7 illustrates the mirror 104 before changing of the inclination angle by a dashed line, and the mirror 104 after changing of the inclination angle by a solid line. As illustrated in FIG. 7, the mirror 104 is displaced by an angle of α(°) clockwise from the original inclination angle due to a temperature rise or the like in the light source units 203 and 204. Accordingly, the luminance-intensity-distribution-variation correction reading line 103b on the document flow reading guide 103 is “deviated” from the original position by a distance determined by an angle of α(°).

FIG. 8 is a diagram schematically illustrating a luminance distribution on the luminance-intensity-distribution-variation correction reading line 103b when “deviation” occurs on the luminance-intensity-distribution-variation correction reading line 103b. FIG. 8 illustrates a case where the inclination angle of the mirror 104 changes by an angle of α(°).

The light (a in FIG. 8) that is radiated onto the document flow reading guide 103 via the light guide member 205 is specularly reflected (a1 in FIG. 8) at the surface of the document flow reading guide 103, so that the reflected light is detected as an intense bright point. Part of the light (b in FIG. 8) that is radiated onto the document flow reading guide 103 via the light guide member 206 becomes weak diffused light (b1 in FIG. 8), and is detected as a weak bright point. As illustrated in FIG. 1, the document passing the reading position is nipped by rollers disposed upstream of the reading position in the transporting direction and rollers disposed downstream of the reading position in the transporting direction. When the attitude of the mirror 104 changes, therefore, the amount of deviation of the reading line on the surface of the document that is read by the light receiving sensor 108 is smaller than the amount of deviation of the luminance-intensity-distribution-variation correction reading line 103b. When “deviation” occurs on the luminance-intensity-distribution-variation correction reading line 103b, therefore, the variation obtained from the luminance value read using the luminance-intensity-distribution-variation correction reading line 103b becomes greater than the intrinsic variation. This makes it difficult to accurately correct the luminance intensity distribution variation.

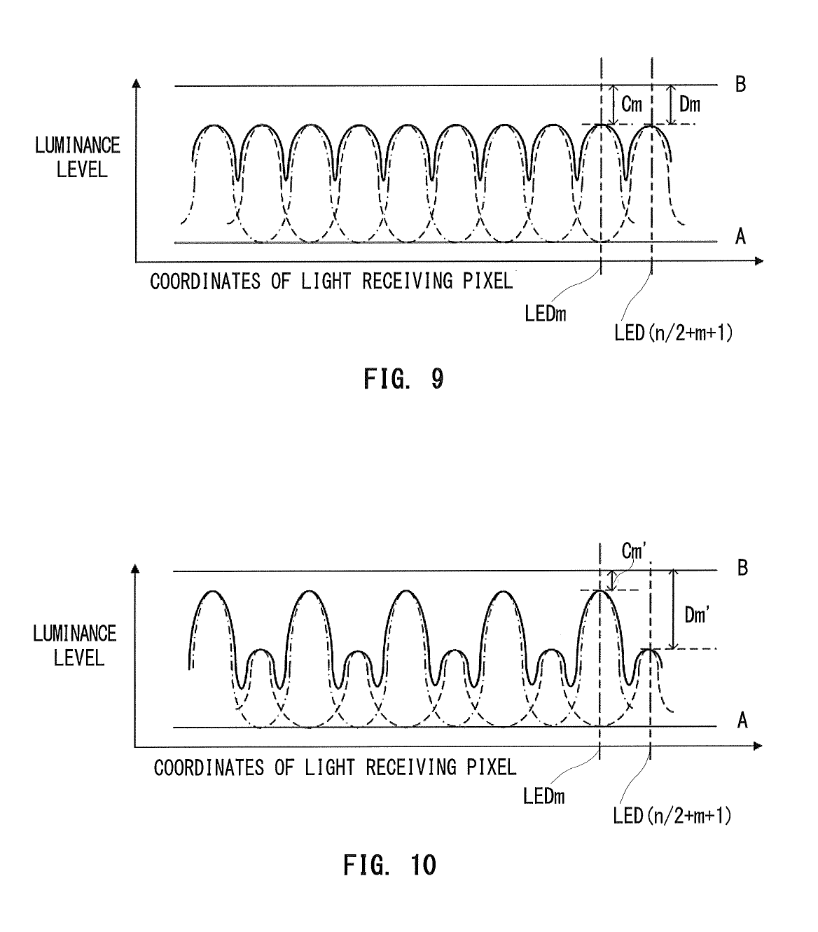

FIG. 9 is a graph showing the luminance distribution on the luminance-intensity-distribution-variation correction reading line 103b before document flow reading starts. The ordinate of the graph in FIG. 9 represents the luminance level, and the abscissa represents the coordinates of the light receiving pixels. In the graph of FIG. 9, a line A and a line B which have constant luminance levels respectively represent the black reference level A and the white reference level B. The luminance level that is indicated by a solid line is the combination of the luminance level of light radiated from the light source unit 203 (alternate long and short dash line in the graph) and the luminance level of light radiated from the light source unit 204 (dashed line in the graph).

“Cm” shown in FIG. 9 represents a difference between the white reference level B when the shading plate 102 as a reference white plate is read and the luminance value of the LEDm (FIG. 4) of the light source unit 203, and is calculated by the document-flow-reading-guide difference calculating circuit 1 (404). Specifically, “Cm” is an average value of pixel output signals in a predetermined range, which has a peak of the luminance level at the pixel coordinates (coordinates of the light receiving pixel) that correspond to the coordinates at which the LEDm is located and are stored in advance in the ROM 409. “Dm” shown in FIG. 9 represents a difference between the white reference level B and the luminance value of the LED(n/2+m+1) (FIG. 4) of the light source unit 204, and is calculated by the document-flow-reading-guide difference calculating circuit 1 (404). Specifically, “Dm” is an average value of pixel output signals in a predetermined range, which has a peak of the luminance level at the pixel coordinates that correspond to the coordinates at which the LED(n/2+m+1) is located and are stored in advance in the ROM 409.

Note that, the average value of pixel output signals in the predetermined range may be, in consideration of stability of the received light signal, an average value of pixel output signals in a predetermined fixed range, or may be a moving average in the units of several tens of pixels.

A value obtained by subtracting the difference “Dm” from the difference “Cm” is “X”. The value “X” is luminance value reference data at the time of correcting “deviation” on the luminance-intensity-distribution-variation correction reading line 103b.

FIG. 10 is a graph showing the luminance distribution on the luminance-intensity-distribution-variation correction reading line 103b when “deviation” occurs on the luminance-intensity-distribution-variation correction reading line 103b. In the graph of FIG. 10, a line A and a line B which have constant luminance levels respectively represent the black reference level A and the white reference level B. The luminance level that is indicated by a solid line is the combination of the luminance level of light radiated from the light source unit 203 (alternate long and short dash line in the graph) and the luminance level of light radiated from the light source unit 204 (dashed line in the graph).

“Cm′” shown in FIG. 10 represents a difference between the white reference level B and the luminance value at the coordinates where the LEDm (FIG. 4) of the light source unit 203 is located, and is calculated by the document-flow-reading-guide difference calculating circuit 2 (405). “Dm′” shown in FIG. 10 represents a difference between the white reference level B and the luminance value at the coordinates where the LED(n/2+m+1) (FIG. 4) of the light source unit 204 is located, and is calculated by the document-flow-reading-guide difference calculating circuit 2 (405). A value obtained by subtracting the difference “Dm′” from the difference “Cm′” is “X′”.

The reading-variation calculating circuit 406 (FIG. 2) subtracts the value “X′” from the value “X” to calculate a variation in luminance.

The luminance unevenness calculating circuit 407 (FIG. 2) calculates the amount of displacement (amount of deviation) of the luminance-intensity-distribution-variation correction reading line 103b where “deviation” is present, based on the calculated variation in luminance. It is possible to determine whether the “deviation” on the luminance-intensity-distribution-variation correction reading line 103b has increased or decreased by determining whether the “amount of deviation” is positive or negative. When the increase in the amount of deviation and the decrease in the amount of deviation exceed predetermined respective levels, luminance unevenness appears prominently.

In this manner, the luminance unevenness calculating circuit 407 determines an increase or a decrease in the luminance value read for each pixel in the light receiving sensor 108 corresponding to the bright point at the main scanning position specified by the coordinates on the document flow reading guide 103.

Each of the differences Cm, Dm, Cm′, and Dm′ as references for determination may be a difference for a specific bright point, or may be an average difference for a plurality of arbitrary bright points.

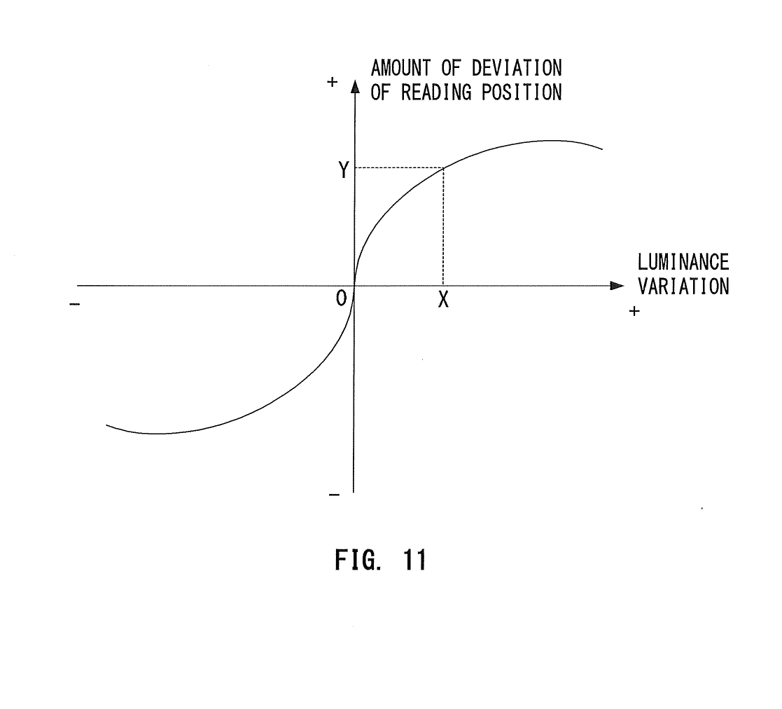

FIG. 11 is a graph showing the relation between a luminance variation (X-X′) and the “amount of deviation” of the luminance-intensity-distribution-variation correction reading line 103b. In the graph of FIG. 11, the origin is set to the luminance-intensity-distribution-variation correction reading line 103b (amount of deviation of 0) before a first document P is read, and the deviation toward the light source unit 203 and the deviation toward the light source unit 204 with respect to the origin are “positive” (+ (plus) direction of the Y axis) and “negative” (− (minus) direction of the Y axis), respectively.

The luminance variation has a correlation that is uniquely determined by the irradiation angle of the illumination light radiated onto the document flow reading guide 103 and the angle of reflection of the mirror 104. When a table specifying the relation between the luminance variation and the amount of deviation, which is shown in FIG. 11, is stored in advance in the ROM 409, the “amount of deviation” of the luminance-intensity-distribution-variation correction reading line 103b can be acquired in accordance with the calculated luminance variation. The registration correction circuit 408 (FIG. 2) performs correction (registration correction) of the deviation of the start position for reading the document P (document leading edge position) based on the calculated amount of deviation.

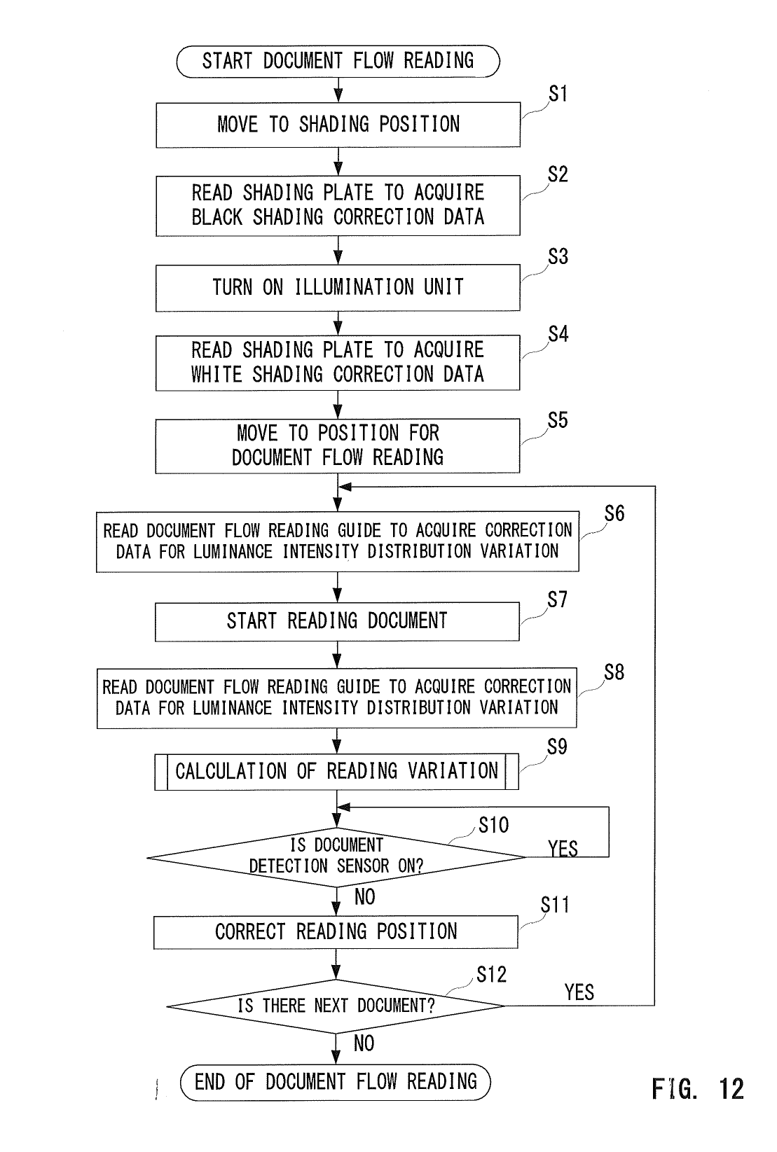

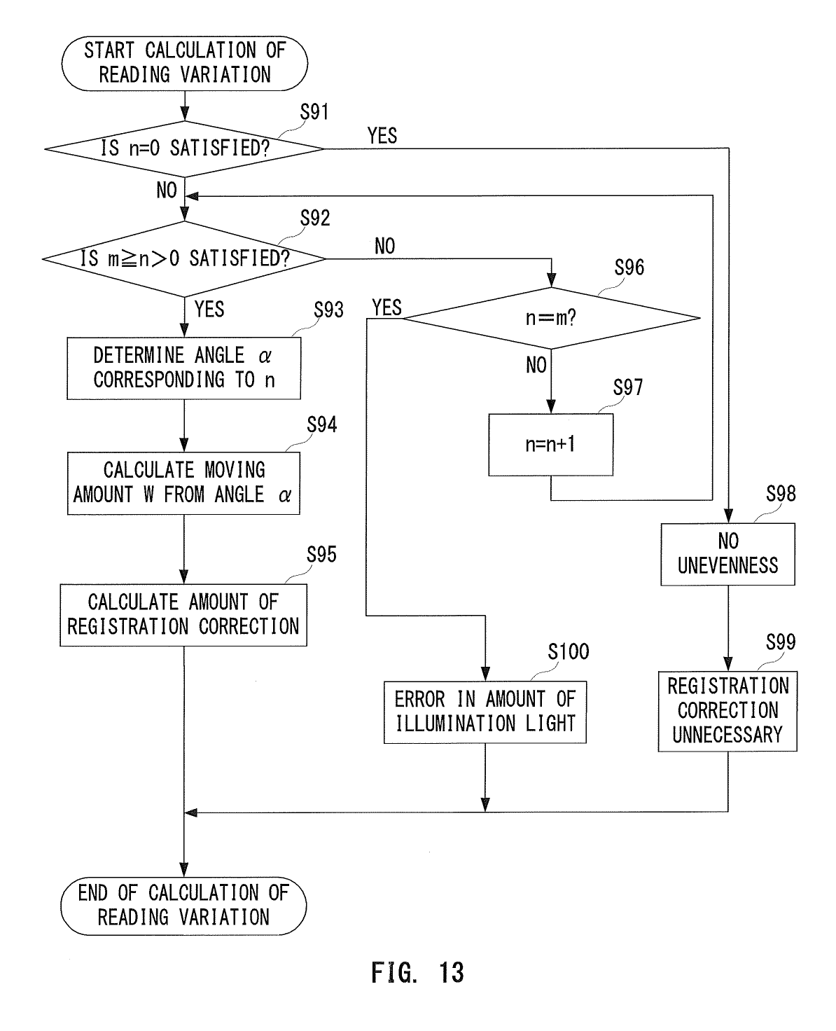

FIG. 12 is a flowchart illustrating procedures of a control process of the image reading apparatus 100.

After a predetermined initialization process ends, the CPU 410 instructs the pressure-plate-motor control circuit 301 to move the illumination unit 101 to a shading position (directly under the shading plate 102) (Step S1). The CPU 410 detects from the result of detection by the home-position sensor 303 that the illumination unit 101 has reached the shading position. Then, with the illumination unit 101 turned off, the CPU 410 instructs reading of the shading plate 102.

The CPU 410 instructs the shading correction circuit 402 to acquire black shading correction data (black reference level A) based on the result of reading the shading plate 102 (Step S2).

The CPU 410 instructs the light-source-unit activation control circuit 220 to turn on the illumination unit 101 (Step S3), and then instructs reading of the shading plate 102.

The CPU 410 instructs the shading correction circuit 402 to acquire white shading correction data (white reference level B) based on the result of reading the shading plate 102 (Step S4). Then, the CPU 410 moves the illumination unit 101 to the position of document flow reading (directly under the document flow reading guide 103) (Step S5). The CPU 410 detects from the result of detection by the home-position sensor 303 that the illumination unit 101 has reached the reading position, and then instructs reading of the surface of the document flow reading guide 103.

The CPU 410 instructs the document-flow-reading-guide difference calculating circuit 1 (404) to calculate the difference (X) between the white shading correction data and the detected luminance value on the surface of the document flow reading guide 103 (Step S6). The calculation result is stored in the storage unit (not shown). Then, the CPU 410 instructs start of reading of the document P (Step S7).

After at least one document P is read, the CPU 410 instructs reading of the surface of the document flow reading guide 103 again. The CPU 410 instructs the document-flow-reading-guide difference calculating circuit 2 (405) to calculate the difference (X′) between the white shading correction data and the currently detected luminance value on the surface of the document flow reading guide 103 (Step S8). The calculation result is stored in the storage unit (not shown).

The CPU 410 instructs the reading-variation calculating circuit 406 to calculate a luminance variation (X-X′) based on those differences. The CPU 410 also instructs the luminance unevenness calculating circuit 407 to calculate the “amount of deviation” of the luminance-intensity-distribution-variation correction reading line 103b based on the luminance variation (Step S9). For example, the luminance unevenness calculating circuit 407 may be configured to calculate the “amount of deviation” of the luminance-intensity-distribution-variation correction reading line 103b in accordance with the luminance variation when a variation (luminance variation) of a predetermined light quantity or more occurs. Those calculation results are stored in the storage unit (not shown).

The luminance unevenness calculating circuit 407 can detect, based on the luminance variation at a specific pixel in the light receiving sensor 108, luminance unevenness at a bright point specified by the coordinates on the document flow reading guide 103 that correspond to the specific pixel. Accordingly, the luminance unevenness calculating circuit 407 may be configured to calculate the “amount of deviation” of the luminance-intensity-distribution-variation correction reading line 103b when the detected luminance unevenness exceeds a predetermined threshold value.

In response to detection of the document detection sensor 304 that transportation of the document P is complete (OFF) (Step S10: YES), the CPU 410 instructs the registration correction circuit 408 to perform registration correction at a timing before a next document P is transported.

Specifically, the registration correction circuit 408 calculates the amount of registration correction from the “amount of deviation” of the luminance-intensity-distribution-variation correction reading line 103b, and moves the illumination unit 101 rightward or leftward horizontally by the amount of the registration correction via the pressure-plate-motor control circuit 301 (Step S11). Accordingly, the reading position for the document can be relatively shifted.

When there is a subsequent document to be read, i.e., when the document P is detected (ON) by the document detection sensor 304, the CPU 410 returns to Step S6. When there is not a subsequent document to be read, i.e., when the document P is not detected (OFF) within a predetermined period of time by the document detection sensor 304, for example, the CPU 410 terminates the document flow reading operation (Step S12: NO).

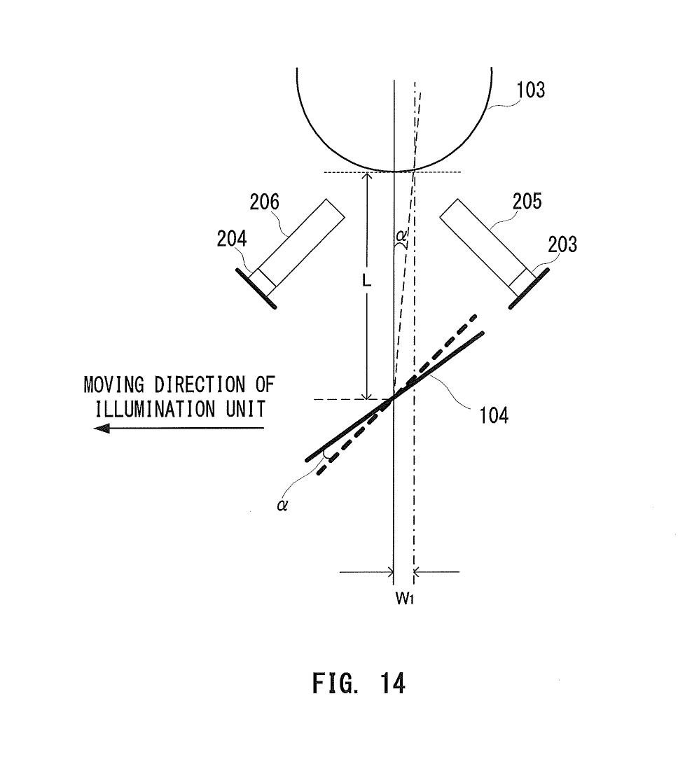

FIG. 13 is a flowchart illustrating detailed procedures of calculating a reading variation (Step S9).

The CPU 410 sequentially compares the luminance variation calculated by the reading-variation calculating circuit 406 with the individual values in the table stored in the ROM 409 (Steps S91 and S92). The table stores inclination angles α(°) in association with the luminance variations n (=0 to m), respectively.

When n=0, i.e., when the luminance variation calculated by the reading-variation calculating circuit 406 is “0” (Step S91: YES), the CPU 410 determines that luminance unevenness has not occurred (Step S98), and determines that registration correction is not necessary (Step S99). In this case, “deviation” has not occurred on the luminance-intensity-distribution-variation correction reading line 103b or the reading position.

When n matching the luminance variation calculated by the reading-variation calculating circuit 406 is detected through the sequential comparison (Step S92: YES), the CPU 410 determines the inclination angle) α(°) corresponding to the matched n (Step S93). Then, the CPU 410 instructs the registration correction circuit 408 to calculate an amount of deviation W of the luminance-intensity-distribution-variation correction reading line 103b based on the inclination angle α(°) (Step S94). The amount of registration correction that is the moving distance of the illumination unit 101 is calculated based on the calculated amount of deviation W (Step S95).

The CPU 410 continues the sequential comparison (Step S92) while incrementing like n=n+1 (Step S97) until n=m (Step S96: NO).

When n matching the luminance variation calculated by the reading-variation calculating circuit 406 is not detected even when n=m (Step S96: NO), the CPU 410 determines that an error in detecting the amount of illumination light has occurred (Step S100), and terminates a sequence of processes.

FIG. 14 is a schematic diagram illustrating the relative positional relation between the mirror 104 and the document flow reading guide 103 when the illumination unit 101 is moved to correct the “deviation” of the reading position for the document P. FIG. 14 illustrates a case where the mirror 104 is displaced by an inclination angle α(°) as illustrated in FIG. 7.

As illustrated in FIG. 14, when the reading position is a position inclined toward the light source unit 203 by the inclination angle α(°), the illumination unit 101 is moved horizontally toward the light source unit 204 (leftward) by a distance W₁. As a result, the reading position for the document P and the luminance-intensity-distribution-variation correction reading line 103b are corrected to the states before document flow reading has started.

The distance W₁ by which the illumination unit 101 is moved is acquired by the following equation 1:

[Equation 1]

W₁=L·tan⁻¹α (1)

As apparent from the above, the image reading apparatus 100 according to this embodiment detects light radiated onto and reflected from the surface of the document flow reading guide 103 at a predetermined timing to be able to calculate a variation in the quantity of light (luminance variation) of the specular reflected light component in the main scanning direction. The “amount of deviation” (amount of displacement) of the reading position is calculated based on the luminance variation, and correction to cancel the amount of deviation is carried out. This makes it possible to correct the “deviation” occurring at the reading position for the document P without employing a complicated configuration. Further, the image reading apparatus can accurately correct luminance intensity distribution variation, thus ensuring accurate image reading.

### Second Embodiment

Reading a document P starts when a predetermined period of time passes after detection of the leading edge of the document P by the document detection sensor 304 (FIG. 2). In this case, when “deviation” occurs at the reading position, for example, reading of the document P may start before the leading edge of the document P reaches the reading position or after the leading edge of the document P passes the reading position.

The following description is given of an image reading apparatus capable of changing the timing of starting reading a document P in accordance with the “amount of deviation” calculated by the registration correction circuit 408.

Same reference numerals are given to the components of the first embodiment that have been described to avoid their redundant descriptions.

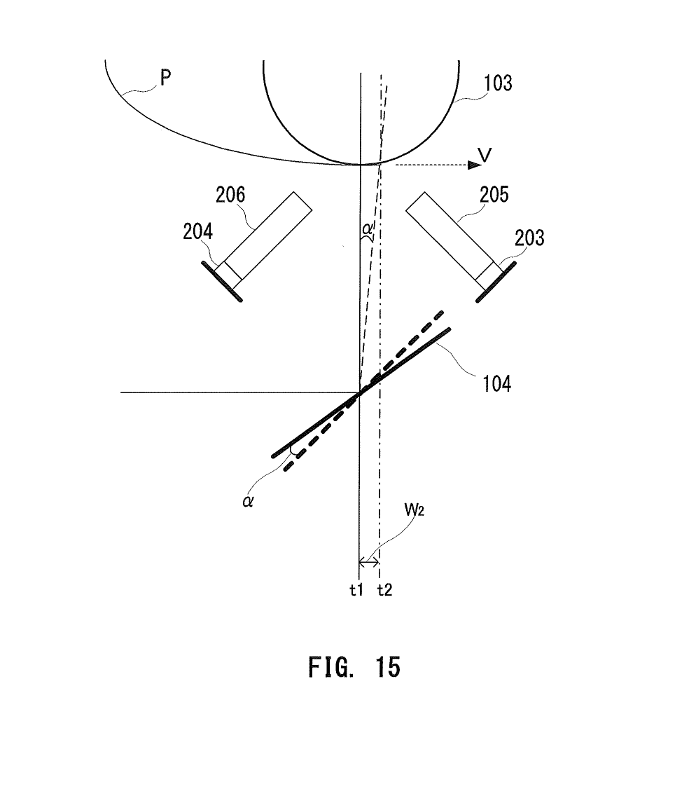

FIG. 15 is a schematic diagram illustrating the relation between times t1 and t2 at which reading of a document P starts and the amount of deviation W₂ of the reading position when a “deviation” occurs on the luminance-intensity-distribution-variation correction reading line, i.e., when a “deviation” occurs at the reading position. FIG. 15 illustrates the mirror 104 before displacement of the inclination angle by a dashed line, and the mirror 104 after clockwise displacement of the inclination angle by α (°) by a solid line. The document P is read while being transported in a direction indicated by a dotted arrow at a velocity V (m/s).

When the reading position is deviated toward the light source unit 203 (rightward as seen from the front of the figure), the leading edge of the document P has not reached the reading position yet at the timing of the time t1 for starting the reading of the document P. It is therefore necessary to adjust the predetermined period of time until the start of the document reading after detection of the leading edge of the document P by the document detection sensor 304 so that reading of the document P starts at the timing of the time t2 in consideration of the amount of deviation W₂ of the reading position.

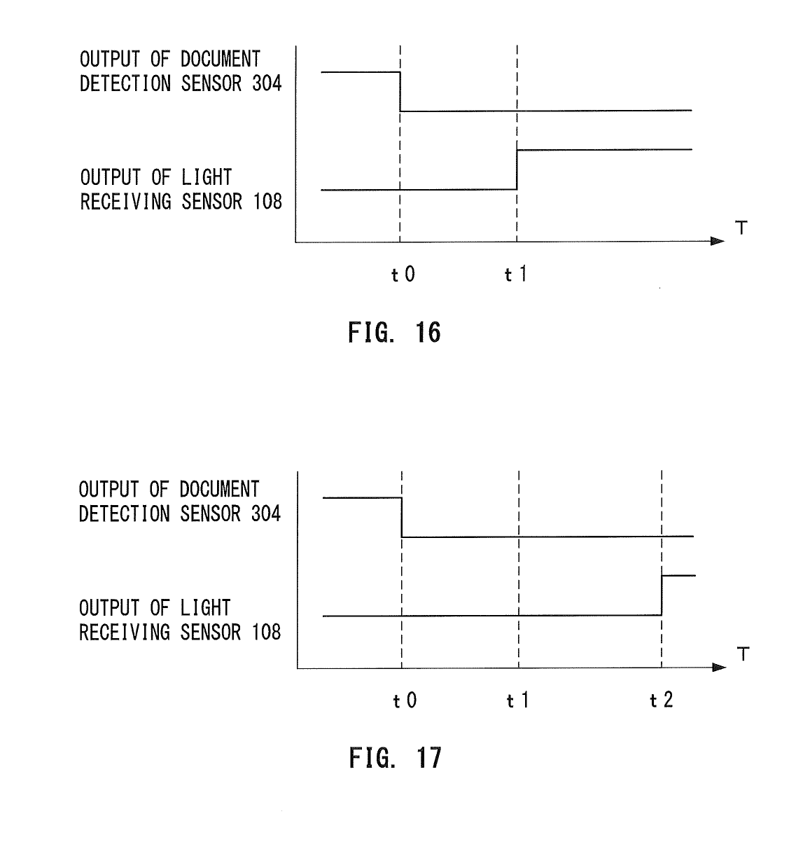

FIG. 16 is a timing chart for reading the document P when “deviation” does not occur at the reading position. The ordinate of the timing chart in FIG. 16 represents the output of the document detection sensor 304 and the output of the light receiving sensor 108, and the abscissa thereof represents the time T.

A time t0 is the time at which outputting of a signal to be output when the document detection sensor 304 detects the leading edge of the document P starts, and a time t1 is the time for starting the output from the light receiving sensor 108 at which reading the document P starts. In other words, the time period from the time t0 to the time t1 is the predetermined period of time from the detection of the leading edge of the document P by the document detection sensor 304 till the start of the document reading.

FIG. 17 is a timing chart for reading the document P when “deviation” occurs at the reading position. The ordinate of the timing chart in FIG. 17 represents the output of the document detection sensor 304 and the output of the light receiving unit 108, and the abscissa thereof represents the time T.

A time t0 is the time at which outputting of a signal to be output when the document detection sensor 304 detects the leading edge of the document P starts, and a time t2 is the time for starting the output from the light receiving sensor 108 at which reading the document P starts. In other words, the timing for starting reading of the document P is changed so as to be delayed from the time +1 to the time +2. Therefore, the time period from the time t0 to the time t2 is the predetermined period of time from the detection of the leading edge of the document P by the document detection sensor 304 till the start of the document reading.

When the reading position is deviated toward the light source unit 203, the timing for starting reading is changed to the time t2 that satisfies time t2>time t1. Specifically, the time t2 is acquired as shown by an equation 3 based on an equation 2 expressing the relation between the amount of deviation W₂ calculated by the registration correction circuit 408, the velocity V (m/s) of transporting the document P, and the times t1 and t2 at which reading of the document P starts.

[Equation 2]

W₂=V×(t2−t1) (2)

[Equation 3]

t2=W₂/V+t1 (3)

As apparent from the above, according to this embodiment, the timing for starting reading of the document P can be changed based on the amount of deviation calculated by the registration correction circuit 408. Accordingly, even when “deviation” occurs at the reading position, the timing for starting document reading is adjusted so that more accurate image reading can be carried out.

When the luminance-intensity-distribution-variation correction reading line is deviated toward the light source unit 204 (leftward as seen from the front of the figure), the timing is changed to the time t2 that satisfies time t1>time t2 so as to set the timing for starting document reading earlier than that set according to the related art.

The above-described embodiments are given just for the purpose of describing the present invention more specifically, and the scope of the present invention is not limited by the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-020757, filed Feb. 5, 2013, which is hereby incorporated by reference herein in its entirety.

What is claimed is:

1. A document reading apparatus configured to read a document that is transported, comprising:
a transporting unit configured to transport the document to a reading position;
a guide member configured to guide the document that is transported at the reading position, the guide member having a curved surface configured to guide the document that is transported;
a first light source unit configured to radiate light toward the reading position from an upstream side in a direction of transporting the document;
a second light source unit configured to radiate light toward the reading position from a downstream side in the direction of transporting the document;
a light receiving sensor configured to receive light and outputting a signal; and
a control unit configured to control the reading position based on the signal output from the light receiving sensor when the light receiving sensor receives reflected light from the guide member under a state in which the first light source unit and the second light source unit radiate the light.

2. A document reading apparatus according to claim 1, wherein the first light source unit and the second light source unit each comprise a plurality of light emitting devices, and positions of the plurality of light emitting devices disposed in the first light source unit differ from positions of the plurality of light emitting devices disposed in the second light source unit.

3. A document reading apparatus according to claim 1, further comprising:
a reflection member configured to guide reflected light from the document to the light receiving sensor;
a holding unit configured to hold the first light source unit, the second light source unit, and the reflection member; and
a drive unit configured to move the holding unit in the direction of transporting the document,
wherein the control unit controls the drive unit to control the reading position for the document.

4. A document reading apparatus according to claim 1, wherein the control unit controls timing for reading the document that is transported.

5. A document reading apparatus according to claim 1, wherein the control unit controls the reading position for the document based on a difference between reference data and data based on the signal.

6. A document reading apparatus according to claim 5, further comprising a reference white plate,
wherein the reference data is calculated based on a signal output from the light receiving sensor when, before reading the document, the light receiving sensor receives reflected light from the reference white plate under the state in which the first light source unit and the second light source unit radiate the light, and a signal output from the light receiving sensor when the light receiving sensor receives reflected light from the guide member under the state in which the first light source unit and the second light source unit radiate the light.

7. A document reading apparatus according to claim 1, wherein the control unit controls the reading position for the document by referring to a table showing a correlation between the difference and an amount of correction of the reading position.

8. A document reading apparatus according to claim 1, wherein the transporting unit includes a first transporting roller disposed upstream of the reading position in the direction of transporting the document, and a second transporting roller disposed downstream of the reading position in the direction of transporting the document.

9. A document reading apparatus according to claim 1, further comprising a document setting portion on which a document is placed,
wherein a plurality of documents placed on the document setting portion are continuously read.

10. A document reading apparatus according to claim 6, wherein shading correction data is calculated based on the signal output from the light receiving sensor when the light receiving sensor receives the reflected light from the reference white plate under the state in which the first light source unit and the second light source unit radiate the light.
